(19) United States
(12) Patent Application Publication
(10) Pub. No.: US 2026/0319635 A1
(43) Pub. Date: Oct. 15, 2026

(54) METHOD OF INPUTTING DIFFERENT STATES FOR PLANNED SCHEDULES

(71) Applicant: C.G.TAE TECHNOLOGY INC., Seongnam-si (KR)

(72) Inventors: Chul Gyu TAE, Seongnam-si (KR); Choe TAE, Seongnam-si (KR)

(21) Appl. No.: 19/101,151

(22) PCT Filed: Aug. 4, 2023
(86) PCT No.: PCT/KR2023/011463

§ 371 Date: Jul. 1, 2025

(30) Foreign Application Priority Data
Aug. 5, 2022 (KR) 10-2022-0097784

(51) Int. Cl. G06F 3/04817; G06Q 10/1093

(52) U.S. Cl. CPC G06F 3/04817; G06Q 10/1093

(57) ABSTRACT

A method of inputting different states for a planned schedule, the method being performed by a device for executing an application, the method comprises: providing a planned timeline in a user interface of the application, wherein the planned timeline displays one or more schedule boxes for planned schedules within a first time range in chronological order, and each of the one or more schedule boxes displays information on two or more categories related to the schedule; and receiving a user selection of one of one or more status icons associated with an execution status of a planned schedule corresponding to at least some of the one or more schedule boxes, wherein the one or more status icons are displayed on each of the one or more schedule boxes.

### TECHNICAL FIELD

The present disclosure relates to a method of inputting different states for a planned schedule using a calendar application. More specifically, the present disclosure provides a method that allows a user to easily and intuitively input whether the planned schedule has been actually carried out after the user has entered their planned schedule. This method not only enables the user to systematically manage their schedule but also allows for the generation of meaningful statistical data related to the schedule.

### BACKGROUND ART

The use of calendar applications on various user devices, such as personal computers (PCs), laptops, tablets, mobile phones, and wearable devices, has become widespread. These calendar applications initially only had functions, such as simply displaying a calendar and allowing users to input simple schedules. However, they have gradually evolved to include various features that enhance the user experience. However, the majority of users of conventional calendar applications often do not fully utilize or are unable to utilize most of the various features offered. In most cases, they use calendar applications merely for sporadically recording a few schedules and setting reminders.

### SUMMARY OF INVENTION

### Technical Problem

Accordingly, an object of the present disclosure is to enhance the user's utilization of a calendar application. As part of this object, the present disclosure provides a method that allows a user to easily and intuitively input whether the planned schedule has been actually carried out after the user has entered their planned schedule. This method not only enables the user to systematically manage their schedule but also allows for the generation of meaningful statistical data related to the schedule.

However, the problems to be solved by the present disclosure are not limited to those mentioned above. The objects not explicitly mentioned but clearly understood by those skilled in the art to which the present disclosure pertains, based on the following description, are also included within the scope of the present disclosure.

### Solution to Problem

According to some aspects of the disclosure, a method of inputting different states for a planned schedule, the method being performed by a device for executing an application, the method comprises: providing a planned timeline in a user interface of the application, wherein the planned timeline displays one or more schedule boxes for planned schedules within a first time range in chronological order, and each of the one or more schedule boxes displays information on two or more categories related to the schedule; and receiving a user selection of one of one or more status icons associated with an execution status of a planned schedule corresponding to at least some of the one or more schedule boxes, wherein the one or more status icons are displayed on each of the one or more schedule boxes.

According to some aspects, the method further comprises: displaying the selected status icon on each of the at least some of the one or more schedule boxes.

According to some aspects, the one or more status icons include at least one of: an adopt icon indicating that the planned schedule corresponding to the schedule box has been executed; a cancel icon indicating that the planned schedule corresponding to the schedule box has not been executed; a defer icon indicating that the execution of the planned schedule corresponding to the schedule box has been deferred; and an undetermined icon prompting the user to determine the execution status of the planned schedule corresponding to the schedule box.

According to some aspects, a first schedule box among the one or more schedule boxes displays the undetermined icon, and the method comprises: in response to user interaction with the first schedule box, displaying at least one of the adopt icon, the cancel icon, and the defer icon for determining the execution status of the planned schedule corresponding to the first schedule box on the first schedule box.

According to some aspects, the user interface further includes a completed timeline that displays one or more schedule boxes for completed schedules within a first time range in chronological order, and the method further comprises: receiving a user selection of the adopt icon displayed on the first schedule box; continuously fixing and displaying the adopt icon on the first schedule box; and generating a second schedule box corresponding to a completed schedule associated with the planned schedule of the first schedule box on the completed timeline.

According to some aspects, the method further comprises: after generating the second schedule box on the completed timeline, receiving user interaction with the first schedule box including the adopt icon; and highlighting the second schedule box corresponding to a completed schedule associated with the planned schedule of the first schedule box.

According to some aspects, the method further comprises: receiving a user selection of the cancel icon displayed on the first schedule box; and continuously fixing and displaying the cancel icon on the first schedule box while displaying the text within the first schedule box with a strikethrough.

According to some aspects, the method further comprises: receiving a user selection of the defer icon displayed on the first schedule box; and continuously fixing and displaying the defer icon on the first schedule box while displaying the first schedule box with hatching.

According to some aspects, the method further comprises: after continuously fixing and displaying the defer icon on the first schedule box, receiving user interaction with the first schedule box including the defer icon; and highlighting and displaying a separate schedule box corresponding to the first schedule box in the right area of the timeline.

According to some aspects, the second schedule box generated by the generating the second schedule box corresponding to a completed schedule associated with the planned schedule of the first schedule box on the completed timeline is displayed distinctly depending on whether the first schedule box corresponds to a planned schedule before the current time or spanning the current time, or whether the first schedule box corresponds to a planned schedule after the current time.

According to some aspects, the planned timeline further includes a vertical time axis indicating the current time.

According to some aspects, the user interface further includes a completed timeline that displays one or more schedule boxes for completed schedules within a first time range in chronological order, and wherein the one or more schedule boxes in the completed timeline are displayed distinctly based on the vertical time axis.

According to some aspects, further comprises: transmitting to a server the ratio of planned schedules in the planned timeline within the first time range for which the adopt icon is displayed, the planned schedules for which the cancel icon is displayed, and the planned schedules for which the defer icon is displayed.

According to some aspects of the disclosure, a device for executing an application to implement a method of inputting different states for a planned schedule, the device comprises: a processor, and a memory including computer-executable instructions, wherein the computer-executable instructions, when executed by the processor, cause the processor to perform operations including: providing a planned timeline in a user interface of the application, wherein the planned timeline displays one or more schedule boxes for planned schedules within a first time range in chronological order, and each of the one or more schedule boxes displays information on two or more categories related to the schedule, and receiving a user selection of one of one or more status icons associated with an execution status of a planned schedule corresponding to at least some of the one or more schedule boxes, wherein the one or more status icons are displayed on each of the one or more schedule boxes.

According to some aspects of the disclosure, a computer-readable recording medium storing computer-executable instructions for implementing a method of inputting different execution states for a planned schedule, wherein the computer-executable instructions, when executed by a processor, cause the processor to perform operations including: providing a planned timeline in a user interface of an application, wherein the planned timeline displays one or more schedule boxes for planned schedules within a first time range in chronological order, and each of the one or more schedule boxes displays information on two or more categories related to the schedule, and receiving a user selection of one of one or more status icons associated with an execution status of a planned schedule corresponding to at least some of the one or more schedule boxes, wherein the one or more status icons are displayed on each of the one or more schedule boxes.

### Advantageous Effects

According to embodiments of the present disclosure, as part of increasing the user's utilization of the calendar application, a method may be provided that allows the user to easily and intuitively input whether the planned schedule has been actually carried out after the user has entered their planned schedule.

In addition, through this, the user of the calendar application may visually check whether the planned schedule has been actually carried out, canceled, or deferred, thereby enabling the user to systematically manage their schedule. Moreover, from the perspective of a calendar management server or an institutional server, it may also be possible to generate meaningful statistical data regarding the planning and execution of individual users' schedules.

However, the effects achievable by the present disclosure are not limited to those mentioned above. Other effects not explicitly mentioned may also be clearly understood by those skilled in the art to which the present disclosure pertains based on the following description.

### BRIEF DESCRIPTION OF THE DRAWINGS

The following drawings attached to the present specification illustrate preferred embodiments of the present disclosure and serve to further aid in understanding the technical spirit of the present disclosure in conjunction with the detailed description. Therefore, the present disclosure should not be construed as being limited only to the matters described in such drawings.

FIGS. 1a and 1b are diagrams illustrating examples of a system for using a calendar application according to an embodiment of the present disclosure.

FIG. 2 is an exemplary diagram illustrating the main screen of the user interface for the calendar application according to an embodiment of the present disclosure.

FIGS. 3 and 4 are exemplary screens illustrating the main window of the user interface for the calendar application according to an embodiment of the present disclosure when scrolled upward and downward, respectively.

FIGS. 5a and 5b are exemplary diagrams illustrating the basic form and the expanded form of the timeline for dates other than today in the user interface of the calendar application according to an embodiment of the present disclosure.

FIG. 6 is a diagram illustrating the timeline 230 of the user interface of the calendar application according to an embodiment of the present disclosure.

FIG. 7a is an exemplary diagram illustrating a process for determining the execution status of a schedule box for a planned schedule in the planned timeline according to an embodiment of the present disclosure.

FIGS. 7b, 7c, and 7d are exemplary diagrams illustrating how the status icons on a schedule box in the planned timeline change depending on the position of the vertical time axis according to an embodiment of the present disclosure.

FIGS. 8a, 8b, and 8c are exemplary diagrams illustrating cases where the user selects an adopt icon, a defer icon, and a cancel icon, respectively, on a schedule box for a planned schedule.

FIG. 9 is a flowchart illustrating a method for inputting the execution status of a planned schedule through a calendar application according to an embodiment of the present disclosure.

FIG. 10a is a flowchart illustrating a case in which the adopt icon is selected for a planned schedule through a calendar application according to an embodiment of the present disclosure.

FIG. 10b is a flowchart illustrating a case in which the defer icon is selected for a planned schedule through a calendar application according to an embodiment of the present disclosure.

FIG. 10c is a flowchart illustrating a case in which the cancel icon is selected for a planned schedule through a calendar application according to an embodiment of the present disclosure.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

### System for Using a Calendar Application

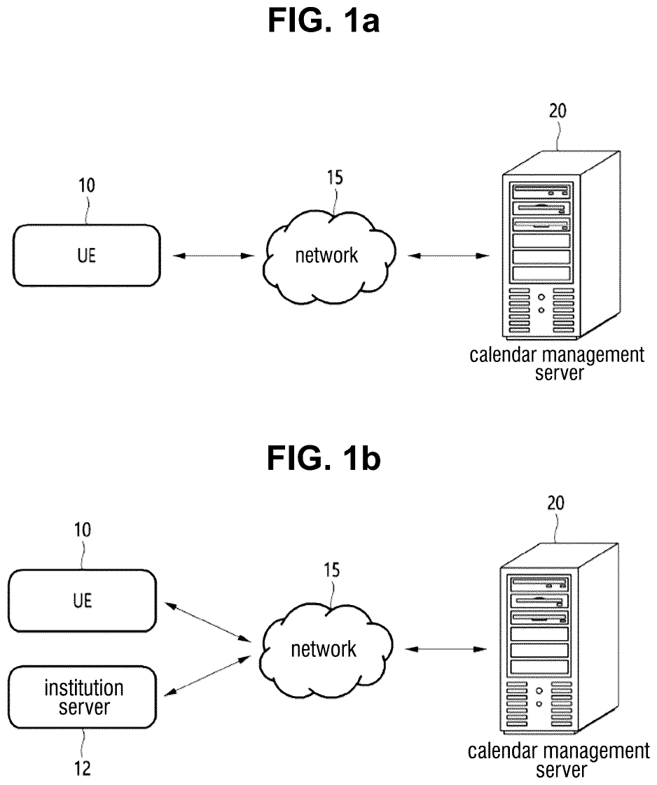

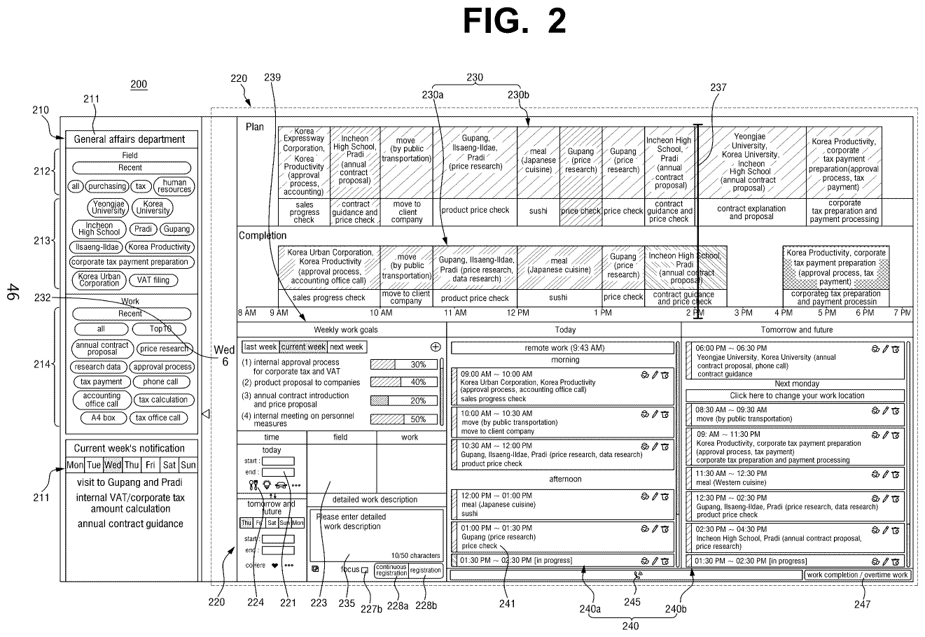

FIGS. 1a and 1b are diagrams illustrating examples of a system for using a calendar application according to an embodiment of the present disclosure.

Referring to the system shown in FIG. 1a, a user device 10 may be connected to a calendar management server 20 via a network 15. According to embodiments of the present disclosure, the calendar application may be installed on the user device 10 or may be used by utilizing calendar application-related resources of the calendar management server 20 in the form of a cloud through the user device 10. Additionally, the calendar application may be distributed across the user device 10 and the calendar management server 20.

The user device 10 may be any device equipped with a display capable of displaying the calendar application, such as a personal computer (PC), laptop, tablet, mobile phone, or wearable device, and may connect to the calendar management server via a network. The same user may use two or more user devices. In this case, the calendar application may operate in synchronization across the user's devices, or it may operate on only one user device at a time. The present disclosure does not limit the implementation method in this regard.

The network 15 may be a wired or wireless network. The user device 10 may connect to the network 15 through a wired LAN cable, through wireless internet such as Wi-Fi, 3G/4G/5G data networks at locations equipped with wireless access points (APs), or by transmitting and receiving wireless signals with peripheral devices to connect to the network 15. The specific method of connection is not limited.

The calendar management server 20 may be a server for providing, servicing, and managing the calendar application. As an example, the calendar management server 20 may provide services and updates for the calendar application, collect various data related to the calendar application, and generate and provide statistical information. The calendar management server 20 may provide the calendar application in the form of a cloud service or deliver calendar-related services through communication with the calendar application installed on the user device 10. The specific operational methods are not limited.

Referring to the system shown in FIG. 1b, the user device 10 and the institution server 12 may be connected to a calendar management server 20 via a network 15. The institution server 12, for example, may be a server operated by various institutions such as companies, schools, public institutions, or research institutes, and the user device 10 may be a personal device belonging to an individual affiliated with such an institution. In this case, the user device 10 may use the calendar application provided through the institution server 12 or, similar to the example in FIG. 1a, use the calendar application installed on the user device 10 itself or by utilizing the resources of the calendar management server 20.

However, unlike the examples in FIGS. 1a and 1b, the calendar application may be used solely on the user device, or it may operate in the form of an intranet only between the institution server and the user device without being connected to the calendar management server 20. The specific implementation methods are not limited.

In the example of the system in FIG. 1a and the example of the system in FIG. 1b, the user device 10 connects to the calendar management server 20 via the network 15, and the schedule data generated by the user utilizing the calendar application on the user device 10 may be collected by at least one of the calendar management server 20 or the institution server 12. For such schedule data to be collected and meaningful statistical data to be generated, the utilization of the calendar application must be enhanced. To achieve this, users need to be provided with motivation to actively use the calendar application. The calendar application and its user interface according to an embodiment of the present disclosure include various elements that enable users to gain positive experiences, such as improved work efficiency and prompt work feedback, through the use of the calendar application. These elements will be described in detail later. Meanwhile, in this regards, there may be issues related to privacy concerns, however, the present disclosure focuses solely on the technical aspects, irrespective of such issues.

### Configuration of the Main Screen of the User Interface for the Calendar Application

FIG. 2 is an exemplary diagram illustrating the main screen of the user interface for the calendar application according to an embodiment of the present disclosure.

In the user interface of the calendar application according to an embodiment of the present disclosure, the term “main screen” refers to the screen presented to the user upon first logging into the calendar application. However, the term “main screen” is used merely for convenience of explanation, and the user may customize the initial screen settings of the calendar application, the configuration may vary depending on the display size of the user device, or the layout of the initial screen may change according to updates to the calendar application. Therefore, the configuration of the main screen described below is merely exemplary.

Additionally, for convenience of explanation, this specification describes “a first time range” as referring to today, “a second time range” as referring to tomorrow and the future (dates after tomorrow), and “a third time range” as referring to the past (yesterday and dates before yesterday). However, the first to third time ranges may each be defined as different time ranges, and they are not limited thereto.

Referring to FIG. 2, the main screen 200 of the user interface for the calendar application may include: a category selection window 210 that allows for the selection and input of one or more categories of schedules; an input panel 220 for entering the time, category, and detailed work description for schedules of today (i.e., the first time range) or tomorrow and the future (i.e., the second time range); a timeline 230 that includes a planned timeline and a completed timeline, which respectively display in chronological order the planned schedules the user intends to carry out today and the completed schedules actually carried out; and a schedule display table 240 that displays the schedules for today and for tomorrow and the future in the form of separate tables.

First, the category selection window 210 allows the user to select and input one or more categories related to the schedule, such as four categories. Among these four categories, the first category 211 may be the highest-level category, and for example, could be the “Department” category. The second category 212 may be the next-level category, which, for example, may classify “Fields” or “Teams.” The third category 213 may be a lower category of the second category 212 and may classify “Projects,” while the fourth category 214 may be a lower category of the third category 213 and may classify “Works.” However, the detailed configuration of each category in the category selection window 210 may be changed by user selection or other factors, and this is not intended to be limiting.

At least some of the first to fourth categories 211, 212, 213, and 214 in the category selection window 210 may be selected by default, considering schedules recently performed by the user, all schedules, and so on. This is designed to minimize the need for the user to input all four categories individually. As a result, by introducing the category selection window 210 according to an embodiment of the present disclosure, an effect is achieved in which the user can input categories with minimal input without feeling burdened.

The input panel 220 is an interface that allows the user to input time, category, and detailed work description for schedules for today (i.e., the first time range) or tomorrow and the future (i.e., the second time range). The schedules entered through the input panel 220 may either be newly registered schedules that will be created in the timeline 230 and the schedule display table 240, or schedules selected for editing from among those already displayed in the timeline 230 and the schedule display table 240.

The input panel 220 may include a time input section 221 for entering or editing the time for a schedule; and an item display section 223, which displays item buttons for categories already selected by the user for the schedule and one or more item buttons recommended for the categories by the calendar application, allowing the user to make selections. Additionally, the input panel 220 according to an embodiment of the present disclosure may include multiple quick buttons 224 for promptly adding repetitive or routine schedules such as meals, recharge (rest), or move; a detailed description input section 225 for entering detailed work descriptions for the schedule; a focus button 227b for indicating that the schedule requires concentration; a registration button 228b for registering the created schedule; and a continuous registration button 228a for registering temporally continuous schedules.

The timeline 230 may include a completed timeline 230a that displays schedule boxes 231a for one or more completed schedules of the user for today in chronological order from left to right, and a planned timeline 230b that displays schedule boxes 231b for one or more planned schedules of the user for today in chronological order from left to right. Each schedule box 231a or 231b may be input and created by the user through the input panel 220. The specific utilization method of timeline 230 will be described in detail later.

The schedule display table 240 may include a first schedule display table 240a for displaying today's schedules in chronological order from top to bottom, and a second schedule display table 240b for displaying tomorrow's and future schedules in chronological order from top to bottom. The first schedule display table 240a and the second schedule display table 240b each include one or more schedule items 241, and each schedule item 241 may be input and created by the user through the input panel 220.

Additionally, the main screen 200 may further include: a goal display section 239 for graphically displaying the progress of work goals; a call history check button 245 that allows the user to save and view key call records; a work completion button 247 that enables the user to select between leaving work or working overtime; and a date display section 232 that displays schedule-related dates, work locations, and other schedule-related information. Additionally, below the category selection window 210, there may be a current week notification display section 211 that provides information on the planned schedules for the current week and a personal notepad (not shown).

As seen in the example of FIG. 2, the main screen 200 may include a category selection window 210 located in the left area of the main screen 200 and a main window 215 located to the right of the category selection window 210. Additionally, the timeline 230 may be located in the upper area of the main window 215, with the goal display section 239 and the input panel 220 positioned in the lower left section of the timeline 230, and the schedule display table 240 positioned in the center and lower right section of the timeline 230.

In the user interface of the calendar application according to an embodiment of the present disclosure, by placing the category selection window 210, which allows for schedule input, in the left section of the main screen 200, and the input panel 220 in the lower central section, the user is enabled to perform schedule input intuitively and easily. Additionally, by arranging schedules in two formats, namely a timeline and a table, respectively in the upper section and the lower right section of the main screen 200, the user is enabled to intuitively and easily check and manage their schedules.

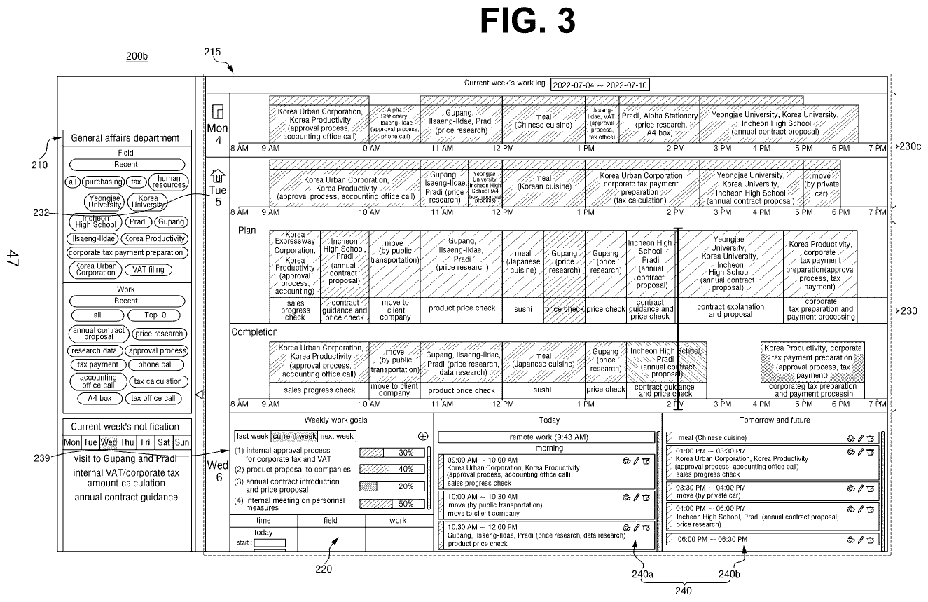

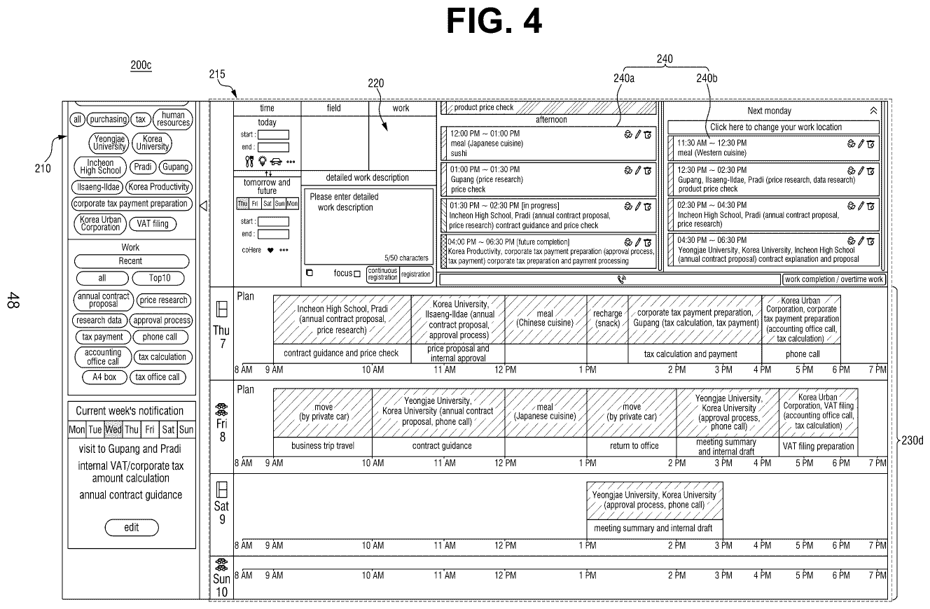

FIGS. 3 and 4 are exemplary screens illustrating the main window of the user interface for the calendar application according to an embodiment of the present disclosure when scrolled upward and downward, respectively. Referring to FIGS. 3 and 4, the main window 215 of the user interface for the calendar application according to an embodiment of the present disclosure is scrollable in the vertical direction.

First, referring to FIG. 3, in an exemplary screen 200b where the main window 215 is scrolled upward by manipulating the scrollbar or similar elements on the right side of the main window 215, one or more past timelines 230c, which display the schedules of yesterday (e.g., Tuesday) and the day before yesterday (e.g., Monday) in chronological order, may be displayed on the timeline 230 that chronologically shows today's (e.g., Wednesday's) schedules.

According to an embodiment of the present disclosure, the date range for the current week (e.g., “Current Week's Work Log 2002 Jul. 4~2022 Jul. 10”) is displayed at the top of the main window 215, and only the timelines for the displayed current week, i.e., the schedule for a one-week period (Monday to Sunday of the week), may be viewed by scrolling. In the example of FIG. 3, today is Wednesday, and the past timeline 230c is shown to include two timelines corresponding to Tuesday and Monday. However, the number of past timelines 230c may vary depending on which day of the week today is.

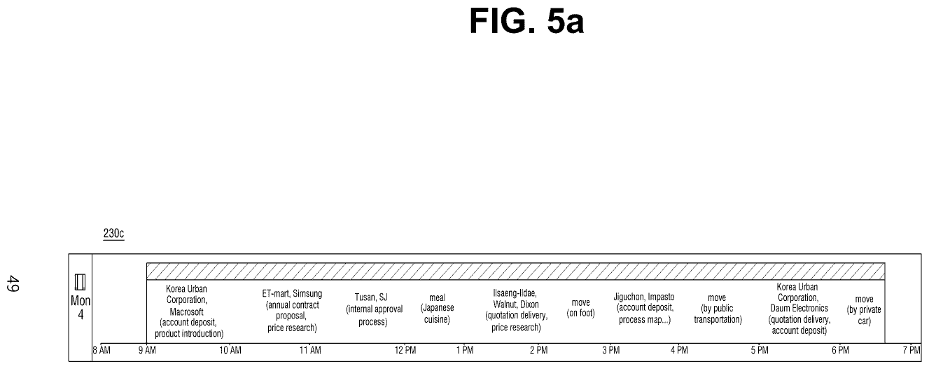

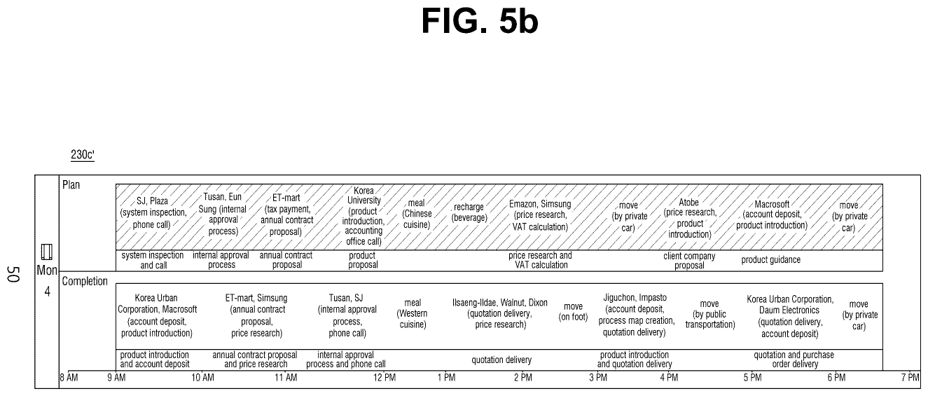

According to an embodiment, the past timeline 230c pertains to schedules prior to today (past) and may include both the timelines for planned schedules the user had set in the past and the timelines for completed schedules the user actually performed. For efficient use of display space, the planned schedules and completed schedules may each be displayed in a collapsed form. This will be described in detail later with reference to FIG. 5a and FIG. 5b.

Referring to FIG. 4, in an exemplary screen 200c where the main window 215 is scrolled downward by manipulating the scrollbar or similar elements on the right side of the main window 215, one or more future timelines 230d, which display the schedules for tomorrow and the future in chronological order by date, may be displayed below the input panel 220 and the schedule display table 240. In the example of FIG. 4, since today is Wednesday, four future timelines 230d corresponding to Thursday through Sunday of the current week are displayed. Since the future timeline 230d pertains to the future, it does not include completed schedules and may only contain planned schedules.

FIGS. 5a and 5b are exemplary diagrams illustrating the basic form and the expanded form of the timeline for dates other than today in the user interface of the calendar application according to an embodiment of the present disclosure.

Referring to FIG. 5a, the past timeline 230c for dates prior to today, in the basic (default) form, may display the planned schedules in a thin format where only the time slots of the schedules are visible, while the completed schedules may be displayed in a state where only the category information of the schedules is visible, with the detailed work descriptions omitted. Overall, it may take the form where the simplified timeline for planned schedules is displayed in a thin format on the simplified timeline for completed schedules, and in this case, the planned schedules and completed schedules may be distinguished by different colors. Displaying past timeline 230c in a simplified form (i.e., a basic form) as described above is intended to efficiently utilize the display space of the main screen and main window. This approach is based on the observation that, in practice, users rarely refer to timelines for dates other than the timeline related to today's schedule.

Referring to FIG. 5b, when the user selects or hovers over any position on the past timeline 230c using an input such as a mouse or touch, the past timeline 230c may transform into an expanded timeline 230c′. In the case of the expanded past timeline 230c′, similar to the timeline 230 for today's date (refer to FIGS. 2 and 3), it may include two timelines: a planned timeline for planned schedules and a completed timeline for completed schedules. The planned schedules and completed schedules may be displayed chronologically, allowing users to view both the category information and detailed schedule information for each schedule.

### Configuration of the Timeline

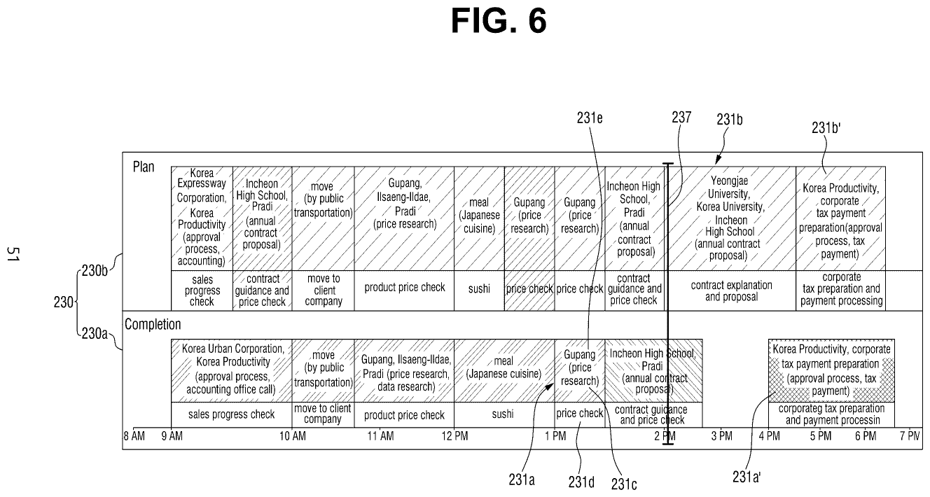

FIG. 6 is a diagram illustrating the timeline 230 of the user interface of the calendar application according to an embodiment of the present disclosure.

Timeline 230 may be configured with two timelines, including a completed timeline 230a in which schedule boxes 231a corresponding to completed schedules within a first time range (e.g., today) are displayed in a chronological order from left to right, and a planned timeline 230b in which schedule boxes 231b corresponding to planned schedules are displayed in a chronological order from left to right. In the example of FIG. 6, the planned timeline 230b is arranged above the completed timeline 230a, however, this is not limited thereto.

According to an embodiment, timeline 230 may be set to display schedules within a time range from 8 AM to 7 PM, even within the time range of today. However, this time range may vary depending on the user of the calendar application or the implementation of the calendar application.

Additionally, in one embodiment, if the user of the calendar application selects “Overtime Mode,” the time range displayed on the timeline may be extended from 8 AM to 12 AM. The selection of such an “overtime work mode” may be made, for example, through a pop-up window generated after the user selects the work completion/overtime work button 247 on the main screen 200 of FIG. 2, however, this is not limited thereto.

Schedule boxes 231a for one or more completed schedules of the user for today, displayed on the completed timeline 230a, may be created based on user input made on the same day. Such user input may be made through input panel 220 and/or category selection window 210. The addition of schedule boxes 231a in the completed timeline 230a may be at least partially synchronized with the addition of schedule items 241 in the first schedule display table 240a within the schedule display table 240.

Each schedule box 231a in the completed timeline 230a may include a first area for displaying the third category 231e of the schedule (e.g., project) and the fourth category 231c of the schedule (e.g., work), as well as a second area for displaying detailed description information 231d of the schedule. A first area of schedule box 231a in the completed timeline 230a may have a first color (e.g., blue) that identifies the schedule as a completed schedule of the user.

The schedule boxes 231b for one or more planned schedules of the user for today, displayed on the planned timeline 230b, may be schedules that the user entered before the current time. Schedule boxes 231b for the user's planned schedules may have the same or similar form and information as schedule boxes 231a by default. However, the first area displaying a third category and a fourth category of the planned schedule may have a second color (e.g., purple) that is different from the color of schedule boxes 231a.

Whether a schedule box generated by the user's schedule input through input panel 220 and/or category selection window 210 is added to the completed timeline 230a or the planned timeline 230b may be automatically determined by the calendar application based on the current time and the time range of the schedule being entered by the user. For example, if the time range of the schedule being entered by the user is before the current time or overlaps with the current time (i.e., a time range that has already passed or is in progress), the schedule may be created as a schedule box 231a in the completed timeline 230a. Conversely, if the time range of the schedule being entered by the user is after the current time (i.e., a future time range), the schedule may be created as a schedule box 231b in the planned timeline 230b.

Additionally, the timeline 230 may include a vertical time axis 237 that indicates the current time. Such a vertical time axis 237 may be displayed across (i.e., passing through) the completed timeline 230a and the planned timeline 230b. The vertical time axis 237 may operate to gradually move to the right as time progresses. A schedule box 231a in the completed timeline 230 that overlaps with the vertical time axis 237 may have a third color (e.g., green) that is different from the first color and the second color.

According to an embodiment, in the completed timeline 230a, a schedule box 231a′ located to the right of the vertical time axis 237, where the vertical time axis 237 has not yet passed, may also be generated. Such a schedule box 231a′ may be a “future confirmed” schedule that is generated when the user has pre-selected a planned schedule (i.e., schedule boxes 231b in the planned timeline 230b) as a schedule that they definitively intend to carry out today (i.e., when the adopt icon is selected). In the example of FIG. 6, when the user has pre-selected a planned schedule corresponding to “Korea Productivity, corporate tax payment preparation” as a schedule they definitively intend to carry out today, a schedule box 231b′ corresponding to the planned schedule is adopted in advance. This example illustrates a case where a schedule box 231a′, representing a future confirmed schedule, is generated in the completed timeline 230a. In the case of the schedule box 231a′, when the schedule box 231b′ is adopted, the time is pre-entered in the time input section of the schedule panel 220, thereby illustrating an example in which the time of schedule box 231a′ for the completed schedule is adjusted accordingly. As such, among the schedule boxes in the completed timeline 230a, a schedule box 231a′ corresponding to a future confirmed schedule located to the right of the vertical time axis 237 may have a fourth color (e.g., dark blue) that is different from the first to third colors.

That is, in the completed timeline 230a of the timeline 230 according to an embodiment of the present disclosure, schedule boxes 231a may be displayed with different colors based on the vertical time axis 237. Additionally, schedule boxes 231b in the planned timeline 230b may be displayed with colors distinct from those of schedule boxes 231a in the completed timeline 230a. Through this, the calendar application of the present disclosure may allow the user to easily and visually distinguish their completed schedules, planned schedules, ongoing schedules, and future confirmed schedules on the timeline through the use of colors.

### Input of Execution Status for Planned Schedules Through Schedule Boxes in the Timeline

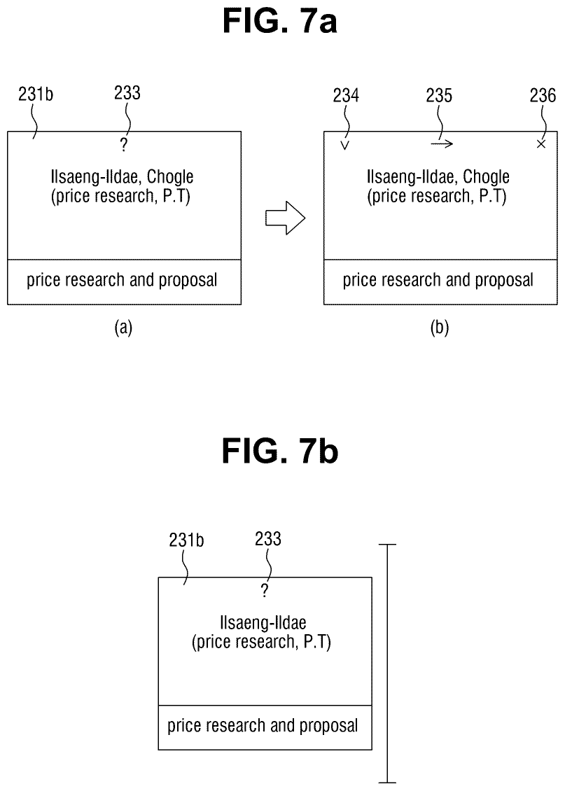

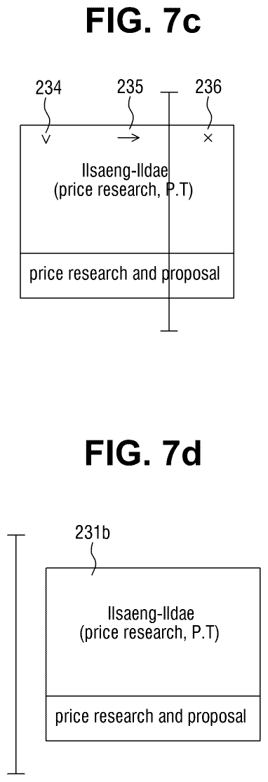

FIG. 7a is an exemplary diagram illustrating a process for determining the execution status of a schedule box for a planned schedule in the planned timeline according to an embodiment of the present disclosure.

Referring to FIG. 7a, according to an embodiment, for a schedule box 231b of a planned schedule displayed in chronological order from left to right in the planned timeline 230b provided in the user interface of the calendar application, the calendar application may display an undetermined icon 233 (e.g., a question mark icon) in the schedule box 231b to prompt the user to determine the execution status of the planned schedule.

Such an undetermined icon 233 may be displayed in the upper central area of schedule box 231b, as shown in FIG. 7a, however, the display position of the undetermined icon 233 is not limited thereto.

The introduction of such an undetermined icon 233 may serve to prompt the user of the calendar application to input the execution status of their planned schedule, ultimately enabling the user to effectively utilize the calendar application.

Referring to FIG. 7b, when user interaction with a schedule box 231b displaying an undetermined icon 233 is detected, the calendar application may respond by removing the undetermined icon 233 (e.g., a question mark icon) from the upper part of schedule box 231b. Instead, at least one of an adopt icon 234, a defer icon 235, and a cancel icon 236 for determining the execution status of the planned schedule corresponding to schedule box 231b may be displayed on schedule box 231b. However, instead of replacing the undetermined icon 233 with a status icon, the undetermined icon and the status icons may be displayed in different positions. The method of displaying the icons is not limited thereto. Additionally, the user interaction herein may refer to cases where the user hovers or clicks the mouse cursor on or near schedule box 231b, or touches schedule box 231b displayed on a touchscreen. However, it is not limited thereto.

According to an embodiment, the adopt icon 234 is an icon for receiving a user selection indicating that the planned schedule corresponding to schedule box 231b has been executed. The cancel icon 236 is an icon for receiving a user selection indicating that the planned schedule corresponding to schedule box 231b has not been executed. The defer icon 235 is an icon for receiving a user selection indicating that the execution of the planned schedule corresponding to schedule box 231b has been deferred. However, although the example in FIG. 7b illustrates a case where the adopt icon 234, defer icon 235, and cancel icon 236 are all displayed in sequence at the top of schedule box 231b, the design of the application may allow for only the adopt icon 234 and the cancel icon 236 to be displayed on schedule box 231b. Additionally, other icons representing different execution statuses of the planned schedule may be added, and the display format is not limited thereto.

As such, in an embodiment of the present disclosure, by displaying at least one of an adopt icon 234, a defer icon 235, and a cancel icon 236 at the upper part of schedule box 231b in the planned timeline 230b for planned schedules, the user may intuitively and easily select one of the three icons 234, 235, and 236 based on the execution status of the planned schedule corresponding to schedule box 231b.

FIGS. 7b, 7c, and 7d are exemplary diagrams illustrating how the status icons on a schedule box in the planned timeline change depending on the position of the vertical time axis according to an embodiment of the present disclosure.

Referring to FIG. 7b, when schedule box 231b is located to the left of the vertical time axis, that is, when the time for the planned schedule corresponding to schedule box 231b has elapsed, an undetermined icon 233 may be displayed on schedule box 231b. This is to prompt the user for the execution status of the planned schedule for which the time has already passed.

Referring to FIG. 7c, when the vertical time axis is positioned on schedule box 231b, that is, when the current time falls within the time range of the planned schedule corresponding to schedule box 231b, one or more status icons, such as an adopt icon 234, a defer icon 235, and a cancel icon 236, may be displayed on schedule box 231b. Through this, the user may be prompted to check the planned schedule and immediately select a status icon.

Additionally, referring to FIG. 7d, when schedule box 231b is located to the right of the vertical time axis, that is, when the time for the planned schedule corresponding to schedule box 231b has not yet passed, neither an undetermined icon nor a status icon may be displayed on schedule box 231b. This is intended both to draw more attention to the undetermined icons for plans whose time has already passed and to account for the possibility that the user has not yet decided on the execution status of the planned schedule.

However, according to an embodiment, in the case of FIG. 7d, when user interaction (such as mouse hovering or touch) is received, status icons such as an adopt icon 234, a defer icon 235, and a cancel icon 236 may be displayed on schedule box 231b. Additionally, the user may select the adopt icon 234 for a planned schedule that they definitively intend to execute today, or select the cancel icon 236 to cancel a planned schedule that they will not be able to execute today. When the cancel icon 236 is selected, the corresponding schedule box 231b may be deleted.

However, the method of displaying icons on schedule box 231b as described above is merely an example and is not limited to the specific implementation. For example, according to another embodiment, the undetermined icon 233 may be displayed on all schedule boxes corresponding to planned schedules whose execution status has not been determined, regardless of the position of the vertical time axis.

Referring again to FIG. 6, in the aforementioned manner, a status icon associated with the execution status of the corresponding planned schedule may be displayed on each of one or more schedule boxes in the planned timeline 230b. Additionally, if there are schedule boxes corresponding to planned schedules for which the user has not yet selected an execution status, an undetermined icon may be displayed on such schedule boxes.

That is, the status icons herein may include an adopt icon indicating that the planned schedule corresponding to the schedule box has been executed, a cancel icon indicating that the planned schedule corresponding to the schedule box has not been executed, a defer icon indicating that the execution of the planned schedule corresponding to the schedule box has been deferred, and an undetermined icon prompting the user to determine the execution status of the planned schedule corresponding to the schedule box.

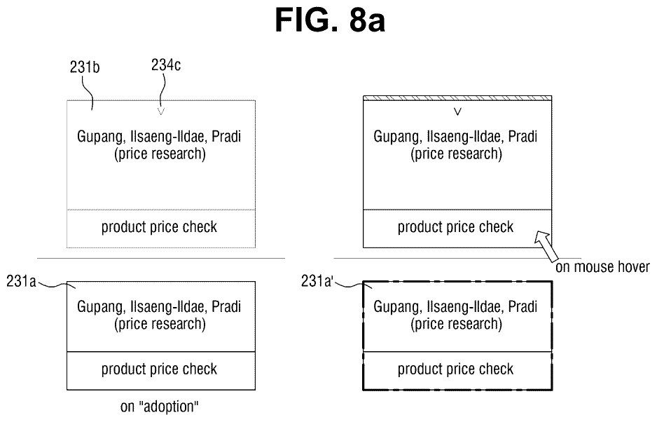

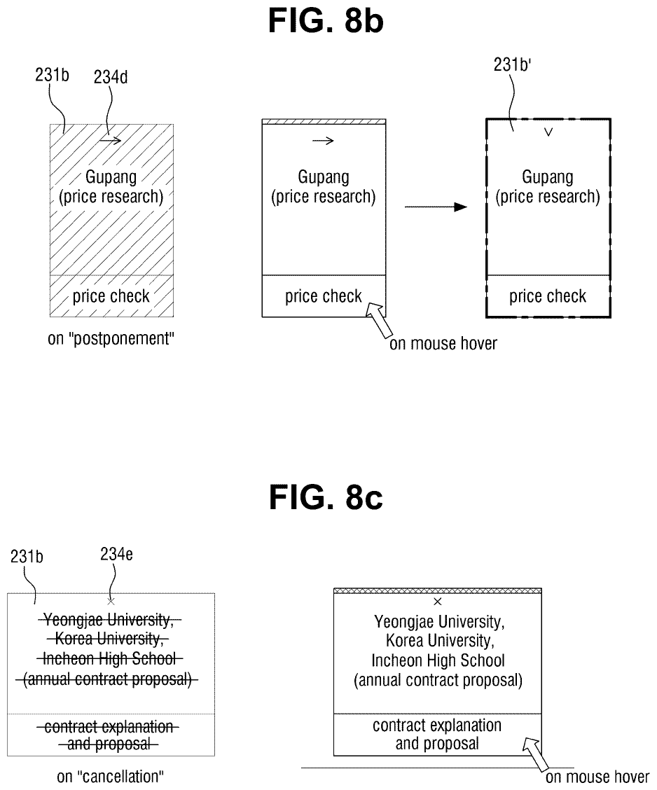

FIGS. 8a, 8b, and 8c are exemplary diagrams illustrating cases where the user selects an adopt icon, a defer icon, and a cancel icon, respectively, on a schedule box for a planned schedule.

Referring to the left illustration of FIG. 8a, when the user selects the adopt icon 234 among one or more status icons on schedule box 231b for a planned schedule, the schedule box 231b may be displayed in a faded state, and an adopt icon (e.g., a check mark) 234c may be fixedly displayed at the upper center of schedule box 231b. Additionally, a schedule box 231a corresponding to a completed schedule associated with the planned schedule corresponding to schedule box 231b may be generated on the completed timeline 230a.

Meanwhile, in some cases, the planned time for the schedule and the actual time at which the planned schedule was executed may differ. In such cases, by pre-entering the time in the time input section of the schedule panel 220 and then adopting schedule box 231b (i.e., selecting the adopt icon 234), the time of the corresponding schedule box 231a generated on the completed timeline 230a may be adjusted to the desired time.

Additionally, referring to the right illustration of FIG. 8a, when user interaction is received on schedule box 231b where the adopt icon 234c has been selected (i.e., when the mouse hovers over it or a touch input is made), the schedule box 231b may be prominently displayed with a color label of the first color at the top. Simultaneously, to indicate which completed schedule in the completed timeline 230a corresponds to the adopted planned schedule, the corresponding schedule box 231a′ for the completed schedule may be highlighted.

Referring to the left illustration of FIG. 8b, when the user selects the defer icon 235 on schedule box 231b for a planned schedule, the schedule box 231b for the planned schedule may be displayed in a faded and hatched state. Additionally, a defer icon (e.g., a rightward arrow) 234d may be fixedly displayed at the upper center of schedule box 231b.

Additionally, referring to the right illustration of FIG. 8b, when user interaction is received on schedule box 231b, where the defer icon 234d is fixedly displayed (i.e., when the mouse hovers over it or a touch input is made), the schedule box 231b may be prominently displayed with a color label of a second color (different from the first color) at the top. Simultaneously, a schedule box corresponding to the deferred planned schedule may be displayed as a separately highlighted schedule box 231b′ at the far right end of the planned timeline 230b.

Additionally, referring to the left illustration of FIG. 8c, when the user selects the cancel icon 236 on schedule box 231b for a planned schedule, the schedule box 231b for the canceled planned schedule may be displayed in a faded state with strikethrough text. Additionally, a cancel icon (e.g., “X”) 234e may be fixedly displayed at the upper center of schedule box 231b. However, when the cancel icon is selected, such a display occurs for a schedule box 231b in the planned timeline 230b where the current time has passed or is in progress. If the cancel icon is selected for a schedule box 231b where the current time has not yet passed, the corresponding schedule box may be removed.

Referring to the right illustration of FIG. 8c, when user interaction is received on schedule box 231b, where the cancel icon 234e is fixedly displayed (i.e., when the mouse hovers over it or a touch input is made), the schedule box 231b may be prominently displayed with a color label of a third color (different from the first color and the second color) at the top.

As such, according to an embodiment of the present disclosure, by allowing the selection of one or more status icons in a schedule box corresponding to a planned schedule in the planned timeline as described above, the user may easily input the execution status of their planned schedule. Through this, the user may visually grasp at a glance whether their planned schedule has been executed, deferred, or canceled. Such a user experience, which allows the execution status of planned schedules to be identified at a glance, may significantly enhance the user's work efficiency and serve as an opportunity for the user to utilize the calendar application more actively.

According to an embodiment of the present disclosure, the calendar application may collect statistical data on the execution status of the user's planned schedules and transmit the data to a calendar management server and/or an institution server. For example, the calendar application may transmit to the server the details and ratios of planned schedules in the planned timeline within a first time range (i.e., today) for which the adopt icon has been selected, the cancel icon has been selected, and the defer icon has been selected.

According to an embodiment of the present disclosure, the calendar application may transmit not only statistical data on the execution status of planned schedules in the planned timeline as described above but also additional information such as the time each planned schedule was entered, the time a status icon was selected for each planned schedule, and the category information of each planned schedule.

Accordingly, the calendar management server and/or an institutional server may derive various forms of meaningful statistical data based on the data collected from calendar applications installed on individual user devices. Such data may include the probability of plan execution for each user, trends in planning and execution, identification of schedule categories that are well executed or frequently unexecuted, and determination of the importance of each schedule. Such statistical data may serve as a foundation for implementing features such as automatic recommendations and Al-related functionalities in the calendar application.

### Method for Inputting Execution Status of Planned Schedules

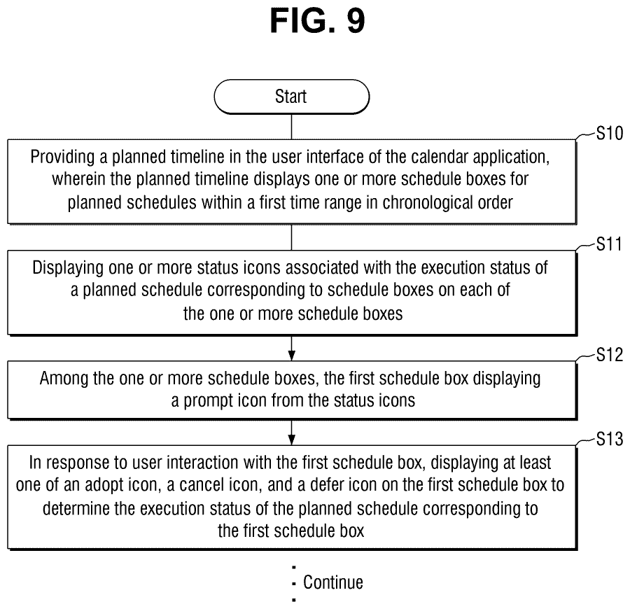

FIG. 9 is a flowchart illustrating a method for inputting the execution status of a planned schedule through a calendar application according to an embodiment of the present disclosure.

Referring to FIG. 9, in step S10, the calendar application provides a planned timeline in the user interface. The planned timeline may include a timeline that displays one or more schedule boxes for planned schedules within a first time range (i.e., today) in chronological order. Additionally, the timeline may also include a completed timeline that displays one or more schedule boxes for completed schedules within the first time range in chronological order.

In step S11, one or more status icons associated with the execution status of the planned schedule corresponding to each schedule box may be displayed on one or more schedule boxes. At this time, the one or more status icons may include at least one of an adopt icon indicating that the planned schedule corresponding to the schedule box has been executed, a cancel icon indicating that the planned schedule corresponding to the schedule box has not been executed, a defer icon indicating that the execution of the planned schedule corresponding to the schedule box has been deferred, and an undetermined icon prompting the user to determine the execution status of the planned schedule corresponding to the schedule box

In step S12, an undetermined icon (e.g., a question mark icon) may be displayed on a first schedule box among the one or more schedule boxes in the planned timeline. Through this undetermined icon, the calendar application may prompt the user to determine the execution status of the corresponding planned schedule.

In step S13, in response to user interaction with the first schedule box, at least one of an adopt icon, a cancel icon, and a defer icon for determining the status of the planned schedule corresponding to the first schedule box may be displayed on the first schedule box.

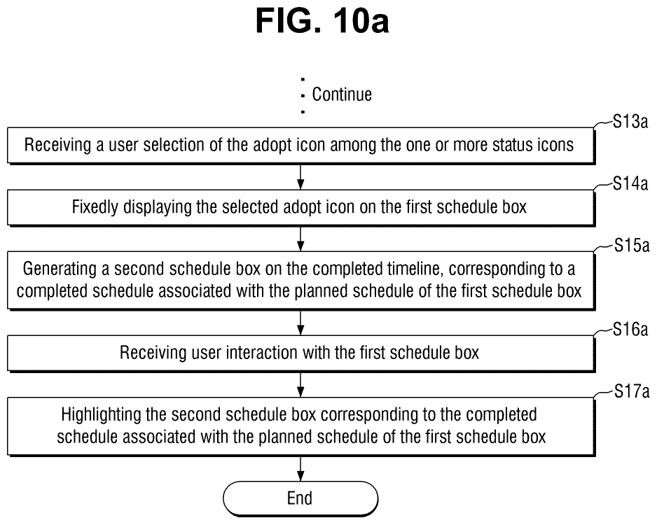

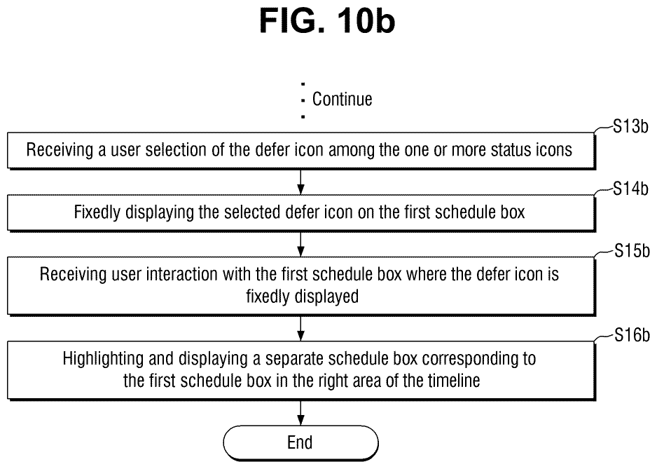

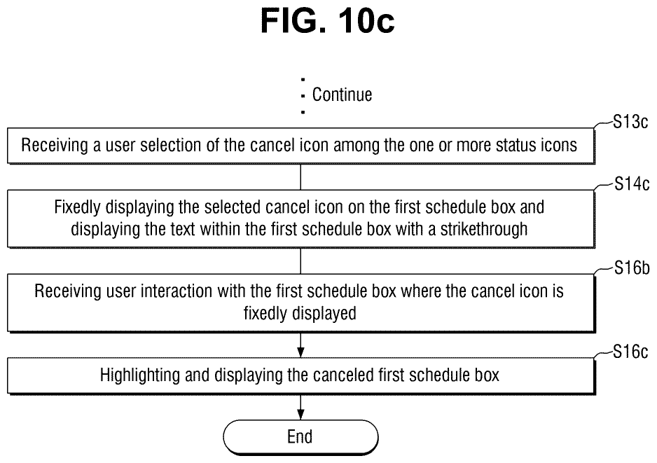

FIG. 10a is a flowchart illustrating a case in which the adopt icon is selected for a planned schedule through a calendar application according to an embodiment of the present disclosure.

Referring to FIG. 10a, in step S13a, a user selection of the adopt icon may be received among the one or more status icons displayed on the first schedule box.

In step S14a, the selected adopt icon may be fixedly displayed in the upper central area of the first schedule box. In step S15a, a second schedule box corresponding to a completed schedule associated with the planned schedule of the first schedule box may be generated on the completed timeline.

In step S16a, after the second schedule box is generated on the completed timeline, user interaction (mouse hovering or touch input on a touchscreen) with the first schedule box, where the adopt icon is fixedly displayed, may be received.

In step S17a, the second schedule box (generated in step S15a) corresponding to the completed schedule associated with the planned schedule of the first schedule box may be highlighted. Through this, the user may identify the completed schedule corresponding to their planned schedule at a glance.

FIG. 10b is a flowchart illustrating a case in which the defer icon is selected for a planned schedule through a calendar application according to an embodiment of the present disclosure.

Referring to FIG. 10b, in step S13b, a user selection of the defer icon may be received among the one or more status icons displayed on the first schedule box.

In step S14b, the selected defer icon may be fixedly displayed in the upper central area of the first schedule box.

In step S15b, user interaction (mouse hovering or touch input on a touchscreen) with the first schedule box, where the defer icon is fixedly displayed, may be received.

In step S16b, a separate schedule box corresponding to the first schedule box may be highlighted and displayed in the right area of the planned timeline. Through this, the user may easily identify at a glance which schedule has been deferred.

FIG. 10c is a flowchart illustrating a case in which the cancel icon is selected for a planned schedule through a calendar application according to an embodiment of the present disclosure.

Referring to FIG. 10c, in step S13c, a user selection of the cancel icon may be received among the one or more status icons displayed on the first schedule box.

In step S14c, the selected cancel icon may be fixedly displayed in the upper central area of the first schedule box, and the text within the first schedule box may be displayed with a strikethrough.

In step S15c, user interaction (mouse hovering or touch input on a touchscreen) with the first schedule box, where the cancel icon is fixedly displayed, may be received.

In step S16c, the first schedule box may be highlighted and displayed. Through this, the user may easily identify at a glance which schedule has been canceled.

### Computer-Readable Recording Medium

The fact that each step or operation of the method according to the embodiments of the present disclosure may be performed by a computer including one or more processors by executing a computer program stored in a computer-readable recording medium is apparent.

The computer-executable instructions stored in the aforementioned recording medium may be implemented through a computer program programmed to perform the corresponding steps, and such a computer program may be stored in a computer-readable recording medium and executed by a processor. The computer-readable recording medium may be a non-transitory readable medium. At this time, the non-transitory readable medium refers to a medium that does not store data for a brief moment, such as registers, cache, or memory, but rather stores data in a semi-permanent manner and is readable by a device. Specifically, programs for performing the various methods described above may be stored in and provided via non-transitory readable media, such as semiconductor memory devices including erasable programmable read-only memory (EPROM), electrically erasable programmable read-only memory (EEPROM), and flash memory devices; magnetic disks such as internal hard disks and removable disks; magneto-optical disks; and non-volatile memory including CD-ROM and DVD-ROM disks.

The methods according to various examples disclosed in this document may be provided as part of a computer program product. The computer program product may be distributed in the form of a machine-readable storage medium (e.g., compact disc read-only memory (CD-ROM)) or may be distributed online through an application store (e.g., Play Store™). In the case of online distribution, at least a portion of the computer program product may be at least temporarily stored in a storage medium such as the memory of a manufacturer's server, an application store server, or an intermediary server, or may be temporarily generated.

As described above, those skilled in the art to which the present disclosure pertains will understand that the present disclosure may be embodied in various specific forms without departing from the technical spirit or essential characteristics thereof. Therefore, the above-described embodiments should be understood as illustrative in all respects and not as limiting. The scope of the present disclosure is defined by the claims set forth below rather than by the detailed description, and all modifications or variations derived from the meaning, scope, and equivalent concepts of the claims should be interpreted as being included within the scope of the present disclosure.

The features and advantages described herein do not encompass all possible features and advantages, and in particular, numerous additional features and advantages will become apparent to those skilled in the art upon consideration of the drawings, the specification, and the claims. Furthermore, it should be noted that the language used in the present specification has been primarily selected for readability and instructional purposes and may not have been chosen to describe or limit the subject matter of the present disclosure.

The foregoing description of the embodiments of the present disclosure has been provided for illustrative purposes. This is not intended to limit the present disclosure to the exact form disclosed or to be made without omission. Those skilled in the art will appreciate that numerous modifications and variations are possible in light of the above disclosure.

Accordingly, the scope of the present disclosure is not limited by the detailed description but is defined by any claims of the application based thereon. Thus, the disclosure of the embodiments of the present disclosure is exemplary and does not limit the scope of the present disclosure as set forth in the following claims.

1. A method of inputting different states for a planned schedule, the method being performed by a device for executing an application, the method comprising:
providing a planned timeline in a user interface of the application, wherein the planned timeline displays one or more schedule boxes for planned schedules within a first time range in chronological order, and each of the one or more schedule boxes displays information on two or more categories related to the schedule; and
receiving a user selection of one of one or more status icons associated with an execution status of a planned schedule corresponding to at least some of the one or more schedule boxes, wherein the one or more status icons are displayed on each of the one or more schedule boxes.

2. The method according to claim 1, further comprising:
displaying the selected status icon on each of the at least some of the one or more schedule boxes.

3. The method according to claim 1, wherein the one or more status icons include at least one of:
an adopt icon indicating that the planned schedule corresponding to the schedule box has been executed;
a cancel icon indicating that the planned schedule corresponding to the schedule box has not been executed;
a defer icon indicating that the execution of the planned schedule corresponding to the schedule box has been deferred; and
an undetermined icon prompting the user to determine the execution status of the planned schedule corresponding to the schedule box.

4. The method according to claim 3, wherein a first schedule box among the one or more schedule boxes displays the undetermined icon, and
the method comprises:
in response to user interaction with the first schedule box, displaying at least one of the adopt icon, the cancel icon, and the defer icon for determining the execution status of the planned schedule corresponding to the first schedule box on the first schedule box.

5. The method according to claim 4,
wherein the user interface further includes a completed timeline that displays one or more schedule boxes for completed schedules within a first time range in chronological order, and
the method further comprises:
receiving a user selection of the adopt icon displayed on the first schedule box;
continuously fixing and displaying the adopt icon on the first schedule box; and
generating a second schedule box corresponding to a completed schedule associated with the planned schedule of the first schedule box on the completed timeline.

6. The method according to claim 5, further comprising:
after generating the second schedule box on the completed timeline,
receiving user interaction with the first schedule box including the adopt icon; and
highlighting the second schedule box corresponding to a completed schedule associated with the planned schedule of the first schedule box.

7. The method according to claim 4, further comprising:
receiving a user selection of the cancel icon displayed on the first schedule box; and
continuously fixing and displaying the cancel icon on the first schedule box while displaying the text within the first schedule box with a strikethrough.

8. The method according to claim 4, further comprising:
receiving a user selection of the defer icon displayed on the first schedule box; and
continuously fixing and displaying the defer icon on the first schedule box while displaying the first schedule box with hatching.

9. The method according to claim 8, further comprising:
after continuously fixing and displaying the defer icon on the first schedule box,
receiving user interaction with the first schedule box including the defer icon; and
highlighting and displaying a separate schedule box corresponding to the first schedule box in the right area of the timeline.

10. The method according to claim 5, wherein the second schedule box generated by the generating the second schedule box corresponding to a completed schedule associated with the planned schedule of the first schedule box on the completed timeline is displayed distinctly depending on whether the first schedule box corresponds to a planned schedule before the current time or spanning the current time, or whether the first schedule box corresponds to a planned schedule after the current time.

11. The method according to claim 1, wherein the planned timeline further includes a vertical time axis indicating the current time.

12. The method according to claim 11, wherein the user interface further includes a completed timeline that displays one or more schedule boxes for completed schedules within a first time range in chronological order, and
wherein the one or more schedule boxes in the completed timeline are displayed distinctly based on the vertical time axis.

13. The method according to claim 3, further comprising:
transmitting to a server the ratio of planned schedules in the planned timeline within the first time range for which the adopt icon is displayed, the planned schedules for which the cancel icon is displayed, and the planned schedules for which the defer icon is displayed.

14. A device for executing an application to implement a method of inputting different states for a planned schedule, the device comprising:
a processor; and
a memory including computer-executable instructions,
wherein the computer-executable instructions, when executed by the processor, cause the processor to perform operations including:
providing a planned timeline in a user interface of the application, wherein the planned timeline displays one or more schedule boxes for planned schedules within a first time range in chronological order, and each of the one or more schedule boxes displays information on two or more categories related to the schedule; and
receiving a user selection of one of one or more status icons associated with an execution status of a planned schedule corresponding to at least some of the one or more schedule boxes, wherein the one or more status icons are displayed on each of the one or more schedule boxes.

15. A computer-readable recording medium storing computer-executable instructions for implementing a method of inputting different execution states for a planned schedule,
wherein the computer-executable instructions, when executed by a processor, cause the processor to perform operations including:
providing a planned timeline in a user interface of an application, wherein the planned timeline displays one or more schedule boxes for planned schedules within a first time range in chronological order, and each of the one or more schedule boxes displays information on two or more categories related to the schedule; and
receiving a user selection of one of one or more status icons associated with an execution status of a planned schedule corresponding to at least some of the one or more schedule boxes, wherein the one or more status icons are displayed on each of the one or more schedule boxes.
